(19) United States
(12) Patent Application Publication
(10) Pub. No.: US 2005/0203244 A1
(43) Pub. Date: Sep. 15, 2005

(54) Thermoplastic polyurethane that exhibits a low formation of combustion gas when burned

(75) Inventors: Christa Hackl, Bad Essen (DE); Marcus Leberfinger, Georgsmarienhutte (DE); Gunter Scholz, Lemforde (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/512,852

(22) PCT Filed: May 21, 2003
(86) PCT No.: PCT/EP03/05312

§ 371 Date: Nov. 12, 2004

(30) Foreign Application Priority Data
May 29, 2002 (DE) 102 24 340.9

(51) Int. Cl. C08K 3/00

(52) U.S. Cl. 524/589

(57) ABSTRACT

The invention relates to flame resistant thermoplastic polyurethane which exhibits a low formation of combustion gas when burned and contains a sufficient quantity of a flame proofing agent to achieve the rating V2, V1 or V0 according to Vertical Burning Test UL94 V of Underwriters Laboratories for thermoplastic polyurethane.

The invention relates to flame-retardant thermoplastic polyurethane which generates little smoke during combustion and which comprises flame retardant in an amount which achieves the V-2, V-1, or V-0 classification for the thermoplastic polyurethane in the Underwriters Laboratories UL 94 V vertical burning test.

Thermoplastic polyurethanes (hereinafter termed TPUs) are semicrystalline materials and belong to the thermoplastic elastomers class. They have good combinatorial properties, such as low abrasion and good chemicals resistance. TPU is generally combustible, and flame retardants therefore need to be added if flame retardancy is to be achieved. Use is usually made of halogen-containing compounds in combination with antimony derivatives. Use is also increasingly being made of halogen-free flame retardants, in particular those based on nitrogen compounds and on phosphorus compounds.

EP-A-617 079 describes the use of melamine derivatives in combination with organic phosphates or phosphonates for preparing flame-retardant TPU. Although the TPUs disclosed as preferred in the publication are advantageous for flame retardancy, the combustion of these substances generates undesirable smoke. Particularly following European harmonization of the relevant test specifications, it is desirable to reduce smoke generation when TPU undergoes combustion.

It is an object of the present invention, therefore, to provide thermoplastic polyurethanes which are flame-retardant and also generate little smoke during combustion, and therefore comply with the relevant test specifications.

We have found that this object is achieved by way of thermoplastic polyurethanes which firstly comprise flame retardant and secondly comprise no, or only small amounts of, aromatic hydrocarbon groups. Surprisingly, it has been found that a high content of aromatic compounds in the polyurethanes or in the additives leads to severe smoke generation.

The invention therefore provides a flame-retardant thermoplastic polyurethane prepared by reacting

a) polyisocyanates with

b) compounds having at least two hydrogen atoms reactive toward isocyanate, and

c) chain extenders,

d) flame retardant,

e) catalysts where appropriate, and

f) additives where appropriate,

the amount of flame retardant (d) used being such as to achieve the V-2., V-1, or V-0 classification in the Underwriters Laboratories UL 94 vertical burning test, and the content of compounds having aromatic hydrocarbon groups in components b) to f) being below 5% by weight, based on the total weight of the thermoplastic polyurethane, and a process for its preparation.

The invention also provides the use of the thermoplastic polyurethanes of the invention for preparing thermoplastic polyurethanes which generate little smoke during combustion and which, in accordance with the Indice de fumée of NF-F16-101, have a maximum smoke density (Dm) of 300, and have a maximum degree of smoke-darkening after 4 minutes (VOF-4) of 650.

For the purposes of this application, aromatic hydrocarbon groups are cyclic hydrocarbon compounds and, respectively, cyclic hydrocarbon structure fragments of compounds which have a conjugated π-electron system with (4n+2) π-electrons, n being a natural number. n is preferably 1. The rings here can therefore be isolated or condensed rings.

Examples of compounds which contain these aromatic hydrocarbon groups are benzene, toluene, and triphenyl phosphate. The term “aromatic hydrocarbon groups” does not apply to heteroaromatics, such as furan, thiophen, melamine or pyridine.

Components (b) to (f) of the thermoplastic polyurethanes of the invention have, based on the total weight of the thermoplastic polyurethanes, a content of below 5% by weight of compounds which contain aromatic hydrocarbon groups. Components (b) to (f) of the thermoplastic polyurethanes of the invention preferably have a content below 2% by weight, more preferably below 1% by weight, particularly preferably below 0.1% by weight, based on the total weight of the thermoplastic polyurethanes, of compounds which contain aromatic hydrocarbon groups. In particular, it is preferable for no components (b) to (f) which contain aromatic hydrocarbon groups to be used to prepare the thermoplastic polyurethanes of the invention.

The following description applies to the TPUs of the invention and to the components (a) to (f) of the composition:

a) organic polyisocyanates which may be used are aliphatic, cycloaliphatic, or aromatic polyisocyanates, preferably diisocyanates. Specific examples which may be mentioned are:

aliphatic diisocyanates, such as hexamethylene 1,6-diisocyanate, 2-methylpentamethylene 1,5-diisocyanate, cycloaliphatic diisocyanates, such as isophorone diisocyanate or cyclohexane 1,4-diisocyanate, aromatic diisocyanates, such as tolylene 2,4- or 2,6-diisocyanate, diphenylmethane 4,4′-, 2,4′-, and 2,2′-diisocyanate, H12-MDI, or advantageously substantially pure diphenylmethane 4,4′-diisocyanate.

In one preferred embodiment, use is made of polyisocyanates without aromatic groups, i.e. preference is given to the use of aliphatic or cycloaliphatic diisocyanates. It is particularly preferable to use hexamethylene diisocyanate.

In one preferred embodiment, therefore, components (a) to (f) of the thermoplastic polyurethanes of the invention have, based on the total weight of the thermoplastic polyurethanes, a content of below 5% by weight, more preferably below 2% by weight, particularly preferably below 1% by weight, in particular below 0.1% by weight, of compounds which contain aromatic hydrocarbon groups. In one very preferred embodiment, none of the components a) to f) contains aromatic hydrocarbon groups.

Where appropriate, subordinate amounts, e.g. amounts of up to 3% by weight, based on the organic diisocyanate, of trifunctional polyisocyanate or of polyisocyanate of higher functionality may replace the diisocyanates whose use is preferred, but the amount of the polyisocyanate should be restricted so that the polyurethanes obtained remain thermoplastically processable. Any relatively large amount of these isocyanates which are more than bifunctional is advantageously compensated by concomitant use of less-than-bifunctional compounds having reactive hydrogen atoms, so as to avoid any excessive chemical crosslinking of the polyurethane.

b) The compounds used having at least two hydrogen atoms reactive toward isocyanate generally comprise relatively high-molecular-weight polyhydroxy compounds with molecular weights of from 500 to 8 000. Examples of those suitable are polyether polyols and polyester polyols, preferably polyetherdiols and polyesterdiols. An example of a compound used is polybutadienediol, which also achieves good results in the preparation of crosslinkable TPUs.. Other compounds which may be used are other polymers containing hydroxy groups and having ether or ester groups in the polymer chain, for example polyacetals, such as polyoxymethylenes, and especially water-insoluble formals, e.g. polybutanediol formal and polyhexanediol formal, and polycarbonates, in particular those made from diphenyl carbonate and 1,6-hexanediol, by transesterification. The polyhydroxy compounds should be at least predominantly linear and have to have a substantially bifunctional structure for the purposes of the isocyanate reaction. The polyhydroxy compounds mentioned may be used as single components or in the form of mixtures.

Suitable polyether polyols may be prepared by known processes, for example by anionic polymerization of alkylene oxides using, for example, alkali metal hydroxides, such as sodium hydroxide or potassium hydroxide, or alkali metal alkoxides as catalysts, and with addition of at least one starter molecule which contains from 2 to 3, preferably 2, reactive hydrogen atoms, or by cationic polymerization, using Lewis acids as catalysts, starting from one or more alkylene oxides having from 2 to 4 carbon atoms in the alkylene radical.

Other polyetherols which may be used are those which may be called low-unsaturation polyetherols. For the purposes of this invention, low-unsaturation polyols are in particular polyether alcohols whose content of unsaturated compounds is smaller than 0.02 meq/g, preferably smaller than 0.01 meq/g. These polyether alcohols are mostly prepared via addition reactions of alkylene oxides, in particular ethylene oxide, propylene oxide, or a mixture of these, onto the starters described above, in the presence of highly active catalysts. Examples of these highly active catalysts are cesium hydroxide or multimetal cyanide catalysts, preferably double-metal cyanide catalysts, also termed DMC catalysts. A DMC catalyst often used is zinc hexacyanocobaltate.

Examples of suitable alkylene oxides are tetrahydrofuran, propylene 1,3-oxide, butylene 1,2- or 2,3-oxide, and particularly preferably ethylene oxide and propylene 1,2-oxide. The alkylene oxides may be used individually, in succession one after the other, or as mixtures. Examples of starter molecules which may be used are: water, organic dicarboxylic acids, such as succinic acid, adipic acid, and/or glutaric acid, alkanolamines, e.g.. ethanolamine, N-alkylalkanolamines, N-alkyldialkanolamines, e.g. N-methyl- and N-ethyldiethanolamine, and preferably bifunctional alcohols, e.g. ethanediol, 1,2-propanediol, 1,3-propanediol, 1,4-butanediol, or diethylene glycol, where these may, where appropriate, contain ether bridges. The starting molecules may be used alone or as a mixture.

It is preferable to use polyetherols based on propylene 1,2-oxide and ethylene oxide, where more than 50%, preferably from 60 to 80%, of the OH groups in these are primary hydroxy groups, and where these have at least a portion of the ethylene oxide arranged as a terminal block. The polymerization products of tetrahydrofuran which contain hydroxy groups are also particularly preferably suitable.

The substantially linear polyetherols usually have number-average molar masses of from 500 to 8 000 g/mol, preferably from 600 to 6 000 g/mol, and in particular from 800 to 3 500 g/mol, and the polyoxytetramethylene glycols here preferably have molar masses of from 500 to 2 800. They may be used either individually or else in the form of a mixture with one another.

Suitable polyester polyols, preferably polyester diols, may be prepared from dicarboxylic acids having from 2 to 12, preferably from 4 to 6, carbon atoms and diols, for example. Examples of dicarboxylic acids which may be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid. The dicarboxylic acids may be used individually or as a mixture, e.g. in the form of a succinic, glutaric, and adipic acid mixture. To prepare the polyesterols, it can, where appropriate, be advantageous to use the appropriate dicarboxylic derivatives instead of the dicarboxylic acids, for example a mono- or diester of a dicarboxylic acid having from 1 to 4 carbon atoms in the alcohol radical, dicarboxylic anhydrides, or dicarboxylic dichlorides. Examples of the diols are glycols having from 2 to 10 carbon atoms, preferably from 2 to 6 carbon atoms, for example ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol. Depending on the properties desired, the diols may be used alone or, where appropriate, in a mixture with one another.

Esters of carbonic acid with the diols mentioned, in particular with those having from 4 to 6 carbon atoms, such as 1,4-butanediol and/or 1,6-hexanediol, are also suitable. Condensation products of ω-hydroxycarboxylic acids, such as ω-hydroxycaproic acid, and preferably polymerization products of lactones, such as unsubstituted or substituted ω-caprolactone, are also suitable.

Preferred polyester diols used are ethanediol polyadipates, 1,4-butanediol polyadipates, ethanediol 1,4-butanediol polyadipates, 1,6-hexanediol neopentyl glycol polyadipates, 1,6-hexanediol 1,4-butanediol polyadipates, and polycaprolactones.

The number-average molar masses of the polyesterdiols are generally from 500 to 6 000 g/mol, preferably from 800 to 3 500 g/mol.

In one preferred embodiment, the component (b) used comprises a polyesterol based on an alkylene glycol adipate, the alkylene radical having from 2 to 6 carbon atoms. The use of alkylene glycol adipates, in particular having an alkylene group having from 2 to 6 carbon atoms, provides the possibility of using only small amounts of, or preferably no, flame retardant (d) to achieve the desired flame retardancy (V-2, V-1 classification in the Underwriters Laboratories UL 94 vertical burning test).

c) The chain extenders used with molecular weights which are generally from 60 to 399, preferably from 65 to 300, are preferably aliphatic diols having from 2 to 12 carbon atoms, preferably having 2, 4, or 6 carbon atoms, e.g. ethanediol, 1,6-hexanediol, diethylene glycol, dipropylene glycol, and in particular 1,4-butanediol. However, diesters of terephthalic acid with glycols having from 2 to 4 carbon atoms are also suitable, as are polytetramethylene glycols with molecular weights of from 162 to 378.

The molar ratios of the components (b) and (c) of the composition may be varied relatively widely to adjust the hardness of the TPUs. Success has been obtained when the molar ratio of component (b) to all of the chain extenders (c) to be used is from 10:1 to 1:10, in particular from 1:1 to 1:4, the hardness of the TPUs rising as the content of (c) increases.

d) The component (d) used in the present invention may comprise halogen-containing or preferably halogen-free flame retardants.. The selection of the flame retardant used is such that components b) to f) have a content of below 5% by weight of compounds having aromatic hydrocarbon groups, based on the total weight of components b) to f). The use of flame retardants which have no aromatic hydrocarbon groups is therefore preferred.

The halogen-containing flame retardants used may comprise a wide variety of fluorinated or preferably chlorinated or brominated compounds. An example of an effective flame retardant is chlorinated polyethylene, where appropriate with antimony (III) oxide as synergist and/or zinc borate. To improve flame retardancy, a number of other metal oxides may also be added to the TPU, examples being ZnO, B₂O₃, Fe₂O₃, CaO. Polytetrafluoroethylene and silica in very small proportions is a suitable antidrip agent.

Other suitable halogen-free flame retardants, alongside alumina trihydrate, for example, and magnesium hydroxide for particularly low-melting TPUs, are the triesters of phosphoric acid, for example trialkyl phosphates. Particular preference is given to oligomeric phosphoric esters or, respectively, phosphonic esters, and also to cyclic phosphates which derive from pentaerythritol or from neopentyl glycol. These phosphoric esters may be used alone or in a mixture with one another, or in a mixture with phosphonic esters. However, it is usual to use phosphoric esters or phosphonic esters.

In one particularly suitable flame retardant combination, the phosphoric esters and/or phosphonic esters are used for the TPU in mixtures together with one or more melamine derivatives. The ratio by weight of phosphate and phosphonate to melamine derivative here is then preferably in the range from 5:1 to 1:5. Melamine derivatives used here preferably comprise melamine cyanurate, melamine phosphate, melamine borate, particularly preferably melamine cyanurate.

In one particularly preferred embodiment, melamine derivatives are used as flame retardant (d) without addition of phosphoric esters. In particular, melamine cyanurate is used as sole flame retardant (d).

The amount added of the flame retardants is sufficient to make the thermoplastic polyurethane of the invention sufficiently flame-retardant to achieve the V-2, V-1, or V-0 classification in the Underwriters Laboratories UL 94 vertical burning test. The amount of flame retardant is preferably sufficient to achieve the classification V-1 or V-0, particularly preferably V-0, to UL 94.

The amount needed of-flame retardant depends on the components used (a) to (c), and (e) and (f). It is usual and general for the amount of flame retardant (c) added to the TPU to be from 0.1 to 60% by weight, preferably from 1 to 40% by weight, and particularly preferably from 5 to 25% by weight, based on the total weight of the stabilized TPU.

In one preferred embodiment, the flame-retardant component (d) used comprises an amount of from 0.1 to 60% by weight, particularly from 5 to 40% by weight, in particular from 15 to 25% by weight, of melamine cyanurate.

e) Suitable catalysts (e) which in particular accelerate the reaction between the NCO groups in the diisocyanates (a) and the hydroxy groups in components (b) and (c) of the composition are the tertiary amines known and conventional in the prior art, e.g. triethylamine, dimethyl cyclohexylamine, N-methylmorpholine, N,N′-dimethylpiperazine, 2-(dimethylaminoethoxy)ethanol, diazabicyclo[2.2.2] octane, and the like, and also in particular organometallic compounds, such as titanic esters, iron compounds, e.g. iron (III) acetylacetonate, tin compounds, e.g. tin diacetate, tin dioctoate, tin dilaurate, or the dialkyltin salts of aliphatic carboxylic acids, for example dibutyltin diacetate, dibutyltin dilaurate, or the like. The amounts usually used of the catalysts are from 0.0001 to 0.1 parts by weight per 100 parts by weight of component (b).

f) Where appropriate, auxiliaries and/or additives (f) may be added to prepare the polyurethanes of the invention. These are well known from the prior art. Mention may be made by way of example of lubricants, inhibitors, stabilizers with respect to hydrolysis, light, heat, or discoloration, dyes, pigments, inorganic and/or organic fillers, and reinforcing agents.

These auxiliaries and/or additives may be introduced into the components of the composition or into the reaction mixture for preparing the TPUs. In another version of the process, these auxiliaries and/or additives (f) may be mixed with the TPU and then melted, or are incorporated directly into the melt.

Besides the components mentioned a), b), and c), and, where appropriate, d) to f), use may also be made of chain regulators, usually with a molecular weight of from 31 to 499. These chain regulators are compounds which have only one functional group reactive toward isocyanates, e.g. monofunctional alcohols, monofunctional amines, and/or monofunctional polyols. In particular for TPUs, flow behavior can be adjusted in a controlled manner via these chain regulators. The amount which may generally be used of chain regulators is from 0 to 5 parts by weight, preferably from 0.1 to 1 part by weight, based on 100 parts by weight of component b), and the chain regulators are defined as part of component c).

The TPUs of the invention are prepared by reacting

a) polyisocyanates with

b) compounds having at least two hydrogen atoms reactive toward isocyanate, and

c) chain extenders,

d) flame retardant,

e) catalysts where appropriate, and

f) additives where appropriate,

the amount of flame retardant (d) used being such as to achieve the V-2, V-1, or V-0 classification in the Underwriters Laboratories UL 94 vertical burning test, and the content of compounds having aromatic hydrocarbon groups in components b) to f) being below 5% by weight, based on the total weight of the thermoplastic polyurethanes.

The reaction may proceed with the usual indices, preferably with an index of from 60 to 120, particularly preferably with an index of from 80 to 110. The index is defined via the ratio of the total number of isocyanate groups used during the reaction in component (a) to the groups reactive toward isocyanates, i.e. the active hydrogen atoms, in components (b) and (c). If the index is 100, there is one active hydrogen atom, i.e. one function reactive toward isocyanates, in components (b) and (c) for each isocyanate group in component (a). If the index is above 100, there are more isocyanate groups present than OH groups.

The TPUs may be prepared by the known processes continuously, for example using reactive extruders or the belt process by the one-shot method or the prepolymer method, or batchwise by the known prepolymer process. In these processes, the components (a), (b), (c), and, where appropriate, (d) to (f) being reacted may be mixed with one another in succession or simultaneously, whereupon the reaction begins immediately.

In the extruder process, the components (a), (b), (c), and also, where appropriate, (d) to (f) of the composition are introduced separately or as a mixture into the extruder, e.g. at from 100 to 280° C., preferably from 140 to 250° C., and reacted. The resultant TPU is extruded, cooled, and pelletized.

After the synthesis, the TPU may, where appropriate, be modified by processing in an extruder. The melt index of the TPU, for example, or its pellet form may be modified in accordance with requirements via this processing.

Components (d) to (f) may be fed during the synthesis or processing of the TPU. It is also possible to prepare concentrates which comprise components (d) to (f) and to feed these into the TPU during processing.

The additives are preferably added in a compounding extruder, preferably using the two-screw process, where the TPU is fed in pellet form, then melted, and the addition of the additives takes place as the extrusion process proceeds. The melt is extruded, cooled, and then, in a continuous process, pelletized, or else subjected to cutting directly after discharge from the die by way of an underwater pelletizer or water-cooled die face pelletizer. However, where appropriate, it is also possible for the flame retardants (d) to be added before synthesis on the belt plant or in the reactive extruder is complete.

The thermoplastic polyurethanes of the invention generate little smoke during combustion. There are various methods available for testing the smoke generated during combustion.

The smoke density may be tested in an NBS smoke density chamber to ASTM E662-79. The attenuation of a light beam due to smoke collecting in the test chamber is measured. The smoke is generated during pyrolysis of the test specimen. The result is expressed in terms of a specific optical density.

DIN 53436/53437 is also commonly used. Here, the plastic to be tested is decomposed thermally in a quartz tube by means of an annular furnace, and smoke density is measured in the measurement device to DIN 53437.

Determination of the Indice de fumée to NF-F16-101 using the smoke density curve to NF X 10-702 is a frequently demanded test, because the assessment here can be made with regard to both maximum smoke density and smoke toxicity. Determination of the smoke density curve involves, inter alia, data on the maximum smoke density (Dm) and the degree of smoke-darkening after 4 minutes (VOF-4), these permitting an assessment of fume generation.

The thermoplastic polyurethanes of the invention generate only little smoke during combustion. The maximum smoke density (Dm) generated during determination of the Indice de fumée to NF-F16-101 using the smoke density curve to NF X 10-702 is preferably less than 300, more preferably less than 250, still more preferably less than 200, particularly preferably less than 150, and in particular less than 110. In addition, the degree of smoke-darkening after 4 minutes (VOF-4) apparent during combustion of the TPUs of the invention during determination of the Indice de fumée to NF-F16-101, using the smoke density curve to NF X 10-702, is preferably less than 650, more preferably less than 450, still more preferably less than 300, particularly preferably less than 200, and in particular less than 150.

Conventional processes, e.g. injection molding or extrusion, are used to process the TPUs of the invention, which are usually in the form of pellets or powder, to give injection-molded or extruded items, e.g. to give films, moldings, rollers, fibers, panels in automobiles, hoses, cable plugs, bellows, drag cables, cable sheathing, gaskets, belts, or attenuating elements. These injection-molded or extruded items may also be composed of compounds comprising the TPU of the invention, and be composed of at least one other thermoplastic, in particular of a polyolefin, polyester, polyether, polystyrene, styrene copolymer, or polyoxymethylene.

The thermoplastic polyurethanes of the invention and the moldings described above comprising the TPUs of the invention may be used in many ways, for example in means of transport, in electrical items, or in machines. Examples of suitable means of transport are motor vehicles, such as cars or trucks, rail vehicles, aircraft, and ships. Examples of electrical items are household devices, televisions, stereo systems, video recorders, computers and accessories, printers and accessories, copiers and accessories, scanners and accessories, switchgear cabinets, and control systems. Examples of machines are packaging machines., robots, wood- or metal-working machines, machine tools, injection-molding machines, extruders, calenders, blown-film machines, CAD machines, milling machines, stamping machines, presses, turning machines, construction-site machines, e.g. excavators, wheel loaders, cranes, conveying systems, industrial trucks, sorting machines, conveyor belts, process monitoring systems, and process control stations.

The invention will be illustrated by the following examples.

### EXAMPLES

### Example 1

A TPU was prepared in the laboratory by the one-shot process. Use was made of 1.0 mol of PTHF 1000 (polytetrahydrofuran with molecular weight 1 000), 2.4 mol of 4,4′-diphenylmethane diisocyanate and 1.4 mol of 1,4-butanediol as chain extender. The PTHF was preheated to 70° C., and the 1,4-butanediol was added, and the diisocyanate was incorporated by mixing at 65° C. Once the temperature had reached 110° C., the mixture was poured into a Teflon mold, onto a heated bed, and after 10 minutes placed in a heating cabinet and heat-conditioned at 80° C. for 15 hours. After the heat-conditioning, the material was ground and dried, and injection-molded plaques were produced.

### Example 2

A TPU was prepared in the laboratory by the one-shot process. Use was made of 1.0 mol of PTHF 1000, 2.4 mol of hexamethylene diisocyanate and 1.4 mol of 1,4-butanediol as chain extender. The PTHF was preheated to 80° C., and the 1,4-butanediol was added, and the diisocyanate was incorporated by mixing at 75° C. Stannous octoate was used as catalyst. Once the temperature had reached 110° C., the mixture was poured into a Teflon mold, onto a heated bed, and after 10 minutes placed in a heating cabinet and heat-conditioned at 80° C. for 15 hours. After the heat-conditioning, the material was ground and dried, and injection-molded plaques were produced.

### Examples 3, 4, and 6

The synthesis takes place as stated in example 1. The amount stated in table 1 of flame retardant was added to the polyetherol PTHF and heated to the starting temperature.

### Example 5

The synthesis takes place as stated in example 2. The amount stated in table 1 of flame retardant was added to the polyetherol PTHF and heated to the starting temperature.

The specimens obtained in examples 1 to 6 were subjected to a smoke density test to NF-F16-101 (Index de Fumée). The results are listed in table 1. All data in table 1 relate to parts by weight. In the case of the UL 94 V combustion test “-” means not passed.

TABLE 1

| | Ex. 1 | Ex. 2 | Ex. 3 | Ex. 4 | Ex. 5 | Ex. 6 |
|---|---|---|---|---|---|---|
| Aromatic TPU | 100 | | 80 | 80 | | 90 |
| Aliphatic TPU | | 100 | | | 90 | |
| Diphenyl cresyl- | | | 20 | | | |
| phosphate | | | | | | |
| Tributyl phosphate | | | | 20 | 10 | 10 |
| Dm | 97 | 70 | 685 | 260 | 100 | 200 |
| maximum smoke density | | | | | | |
| VOF-4 | 190 | 20 | 1 360 | 605 | 125 | 420 |
| degree of smoke darkening | | | | | | |
| after 4 min | | | | | | |
| UL 94 combustion test | — | — | V-2 | V-2 | V-2 | V-2 |

Examples 1 and 2 show the comparison between aromatic TPU and aliphatic TPU without addition of any flame retardant. In these two examples, although the desired combustion with little generation of smoke is achieved the desired flame retardancy is not achieved (combustion test to UL 94 V not passed).

Examples 3 and 4 show the comparison between aromatic and aliphatic flame retardant in TPU based on aromatic isocyanates. Example 3 lies outside the claimed range of the invention and does not provide the desired combustion with little smoke generation.

Examples 5 and 6 show the comparison between a TPU based on an aliphatic or aromatic isocyanate when use is-made of an aliphatic flame retardant. It can be seen that the use of aliphatic flame retardants and of aliphatic isocyanates is particularly preferable.

1. A flame-retardant thermoplastic polyurethane prepared by reacting
a) one or more aliphatic polyisocyanates with
b) one or more compounds having at least two hydrogen atoms reactive toward isocyanate, and
c) one or more chain extenders,
d) one or more flame retardants,
e) one or more catalysts where appropriate, and
f) one or more additives where appropriate,
the amount of said one or more flame retardants (d) used being such as to achieve the V-2, V-1, or V-0 classification in the Underwriters Laboratories UL 94 vertical burning test, and the content of compounds having aromatic hydrocarbon groups in components b) to f) being below 5% by weight, based on the total weight of the thermoplastic polyurethane.

2. The thermoplastic polyurethane as claimed in claim 1, wherein the amount of the flame retardant d) is from 5 to 50% by weight, based on the total weight of the thermoplastic polyurethane.

3. The thermoplastic polyurethane as claimed in claim 1, wherein the component (b) comprises a polyesterol comprising an alkylene glycol adipate.

4. A process for preparing flame-retardant thermoplastic polyurethanes by reacting
a) one or more aliphatic polyisocyanates with
b) one or more compounds having at least two hydrogen atoms reactive toward isocyanate, and
c) one or more chain extenders,
d) one or more flame retardants,
e) one or more catalysts where appropriate, and
f) one or more additives where appropriate,
the amount of said one or more flame retardants (d) used being such as to achieve the V-2, V-1, or V-0 classification in the Underwriters Laboratories UL 94 vertical burning test, and the content of compounds having aromatic hydrocarbon groups in components b) to f) being below 5% by weight, based on the total weight of the thermoplastic polyurethanes.

5-7. (canceled)

8. The thermoplastic polyurethane as claimed in claim 1, wherein said thermoplastic polyurethane, in accordance with the Indice de fumée of NF-F16-101, have a maximum smoke density (Dm) of less than 300, and have a maximum degree of smoke-darkening after 4 minutes (VOF-4) of less than 650.

9. A film, molding, roller, fiber, panel in an automobile, hose, cable plug, bellow, drag cable, cable sheathing, gasket, belt, or attenuating element, wherein said film, molding, roller, fiber, panel in an automobile, hose, cable plug, bellow, drag cable, cable sheathing, gasket, belt, or attenuating element comprises said thermoplastic polyurethane as claimed in claim 1.
